(19) United States
(12) Patent Application Publication
(10) Pub. No.: US 2019/0358671 A1
(43) Pub. Date: Nov. 28, 2019

(54) ULTRASONIC WAVE OUTPUT DEVICE

(71) Applicant: DENSO CORPORATION, Kariya-city (JP)

(72) Inventor: Toshiaki NAKAYAMA, Kariya-city (JP)

(21) Appl. No.: 16/536,076

(22) Filed: Aug. 8, 2019

Related U.S. Application Data
(63) Continuation of application No. PCT/JP2018/004646, filed on Feb. 9, 2018.

(30) Foreign Application Priority Data
Feb. 13, 2017 (JP) 2017-024069

(51) Int. Cl. B06B 1/02; H04R 1/02

(52) U.S. Cl. CPC B06B 1/02; H04R 1/02

(57) ABSTRACT

An ultrasonic wave output device is provided. The ultrasonic wave output device includes at least one ultrasonic wave output portion, a hold portion, and a heat conductor. The at least one ultrasonic wave output portion includes at least one lead wire to which an input signal is input. The at least one ultrasonic wave output portion outputs an ultrasonic wave in response to the input signal. The hold portion has a space inside. The hold portion holds the at least one ultrasonic wave output portion outside the space with the at least one lead wire inserted in the space. The heat conductor is in contact with an inner wall of the space and the at least one lead wire. The heat conductor has a thermal conductivity higher than a thermal conductivity of air.

### CROSS REFERENCE TO RELATED APPLICATIONS

The present application is a continuation application of International Patent Application No. PCT/JP2018/004646 filed on Feb. 9, 2018, which designated the U.S. and claims the benefit of priority from Japanese Patent Application No. 2017-024069 filed on Feb. 13, 2017. The entire disclosures of all of the above applications are incorporated herein by reference.

### TECHNICAL FIELD

The present disclosure relates to an ultrasonic wave output device that outputs an ultrasonic wave.

### BACKGROUND

A heating element that is immersed in a refrigerant to be cooled has been proposed.

### SUMMARY

The present disclosure provides an ultrasonic wave output device. The ultrasonic wave output device includes at least one ultrasonic wave output portion, a hold portion, and a heat conductor. The at least one ultrasonic wave output portion may include at least one lead wire to which an input signal is input. The hold portion may have a space inside. The hold portion may hold the at least one ultrasonic wave output portion outside the space with the at least one lead wire inserted in the space. The heat conductor may be in contact with an inner wall of the space and the at least one lead wire. The heat conductor has a thermal conductivity higher than a thermal conductivity of air.

### BRIEF DESCRIPTION OF DRAWINGS

The above and other objects, features and advantages of the present disclosure will become more apparent from the following detailed description made with reference to the accompanying drawings. In the drawings:

FIG. 1 is a cross section view of an ultrasonic wave output device according to an embodiment; and

FIG. 2 is a rear view of an ultrasonic wave output device according to another embodiment.

### DETAILED DESCRIPTION

For example, cooling may be performed in an ultrasonic wave output portion that outputs an ultrasonic wave. The inventor has found that a refrigerant inhibits the ultrasonic wave output from the ultrasonic wave output portion when the refrigerant to be cooled for a heating element is applied to the ultrasonic wave output device. Thus, there is a difficulty in applying such type of refrigerant to the ultrasonic wave output device.

An example embodiment of the present disclosure provides an ultrasonic wave output device. The ultrasonic wave output device includes at least one ultrasonic wave output portion, a hold portion, and a heat conductor. The at least one ultrasonic wave output portion includes at least one lead wire to which an input signal is input. The at least one ultrasonic wave output portion outputs an ultrasonic wave in response to the input signal. The hold portion has a space inside. The hold portion holds the at least one ultrasonic wave output portion outside the space with the at least one lead wire inserted in the space. The heat conductor is in contact with an inner wall of the space and the at least one lead wire. The heat conductor has a thermal conductivity higher than a thermal conductivity of air.

With the example ultrasonic wave output device, when the ultrasonic wave output portion generates heat, the heat conductor releases the heat transmitted to the at least one lead wire to the outside of the space. Thus, the ultrasonic wave output portion can be cooled as compared with the case where the space is filled with air.

Embodiments of the present disclosure will be described below with reference to the drawings.

### 1. Embodiment

[1-1. Configuration]

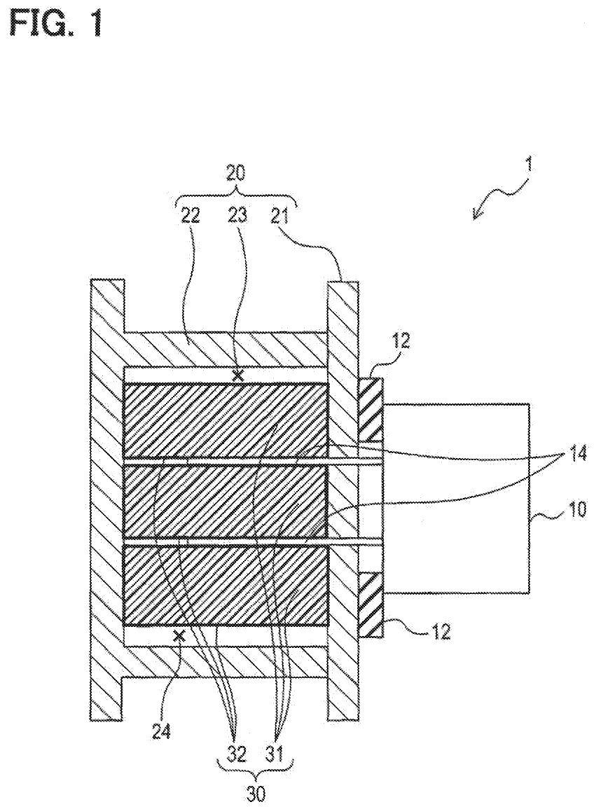

An ultrasonic wave output device 1 shown in FIG. 1 includes an ultrasonic speaker 10, a housing 20, and a plurality of heat conductors 30.

The ultrasonic speaker 10 includes a pair of lead wires 14 to which an input signal is input. The ultrasonic speaker 10 outputs an ultrasonic wave in response to the input signal. Alternatively, the ultrasonic speaker 10 may be constituted by a parametric speaker that outputs an audible sound by the modulated ultrasonic wave.

The housing 20 includes a printed circuit board 21 and a main body 22. The printed circuit board 21 is constituted as a well-known printed circuit board. The printed circuit board 21 is electrically connected to the lead wires 14, and is formed with a conduction path for supplying the input signal to the lead wires 14.

A portion of the lead wires 14 required for electric conduction is a portion from the ultrasonic speaker 10 to the printed circuit board 21. A portion on the tip side from the printed circuit board 21 is left without cutting so that the tip portion is capable of using for heat dissipation. That is, the lead wire 14 functions as a heat sink when the ultrasonic speaker 10 generates heat.

The portion on the tip side indicates a portion on the left side of the lead wires 14 in the drawing of FIG. 1 with respect to the printed circuit board 21, that is, a portion on the opposite side to the ultrasonic speaker 10.

The main body 22 is made of metal such as aluminum alloy and includes a bottom surface and a side wall. In FIG. 1, the bottom surface indicates a member on the left from the heat conductor 30, which will be described later, in the main body 22. In FIG. 1, the side wall indicates upper and lower members with respect to the heat conductor 30 in the main body 22.

The side wall is disposed to surround the bottom surface, and a space 23 is formed by the bottom surface and the side wall. The main body 22 is assembled with the printed circuit board 21 which functions as a cover of the main body 22. As a result, the space 23 is constituted as a closed space whose periphery is closed.

The printed circuit board 21 holds the ultrasonic speaker 10 outside the space 23 with the lead wire 14 inserted in the space 23. The ultrasonic wave output device 1 may include a sealing member 12. The sealing member 12 is made of resin such as rubber, rubber adhesive, or the like. The sealing member 12 has a function of closing a gap between the ultrasonic speaker 10 and the printed board 21.

The sealing member 12 also has a function as a vibration suppressing member that makes it difficult for the vibration generated by the ultrasonic speaker 10 to be transmitted to the printed circuit board 21. The sealing member 12 preferably has a thermal conductivity higher than the thermal conductivity of air.

The sealing member 12 may be constituted by a metal member as long as the sealing member 12 has a function of closing the gap between the ultrasonic speaker 10 and the printed circuit board 21. The metal member generally has the high thermal conductivity. Thus, when the metal member is used for the sealing member 12, the heat generated by the ultrasonic speaker 10 can be easily released to the housing 20.

Each of the plurality of heat conductors 30 includes a heat radiation gel 31 and a gel enclosure 32. The plurality of heat conductors 30 are disposed in the space 23 of the housing 20. The heat radiation gel 31 is constituted as a gel-like substance having a thermal conductivity higher than the thermal conductivity of air. The heat radiation gel 31 may be a known heat radiation gel constituted as a gel-like refrigerant including silicon and metal powder.

The metal powder included in the heat radiation gel 31 may be constituted by a high heat conductive material such as alumina. Liquid whose thermal conductivity is higher than air may be replaced to the heat radiation gel 31. A high thermal conductivity substance which is solid may be included in the liquid.

The gel enclosure 32 is formed to have a shape of a bag that is closed. The gel enclosure 32 is disposed in the space 23 of the housing 20 in a state in which the heat radiation gel 31 is accommodated. The bag herein has one or more inlets. The bag is capable of accommodating an object from the inlet, and has a shape capable of closing the inlet after accommodating the object.

In the present embodiment, the gel enclosure 32 is in a state in which the heat radiation gel 31 is enclosed by closing the bag without a gap so as to prevent the heat dissipation gel 31 from leaking out.

In the heat conductor 30, the heat radiation gel 31 is enclosed in the gel enclosure 32. The heat conductor 30 contacts the inner wall of the space 23 and the lead wires 14. The heat conductor 30 has the thermal conductivity higher than the thermal conductivity of air. That is, the heat conducting portion 30 may have the thermal conductivity higher than the thermal conductivity of air in a configuration in which the heat radiation gel 31 and the gel enclosure 32 are combined.

The gel enclosure 32 is constituted as an insulator. The insulator may be constituted by a general insulator and may have a resistivity [Ωm] of 10 to the power of 6 or more.

Although it is preferable to fill the space 23 without a gap, the heat conductor 30 may have a gap 24 in part.

[1-2. Effects] According to the embodiment described above, the following effects are achieved.

(1a) The ultrasonic wave output device 1 described above includes the ultrasonic speaker 10, the housing 20, and the heat conductor 30. The ultrasonic speaker 10 includes at least one lead wire 14 to which the input signal is input. The ultrasonic speaker 10 outputs the ultrasonic wave in response to the input signal.

The housing 20 has the space 23 inside. The housing 20 holds the ultrasonic speaker 10 outside the space 23 with the lead wire 14 inserted in the space 23. The heat conductor 30 is in contact with the inner wall of the space 23 and the lead wire 14 and has the thermal conductivity higher than the thermal conductivity of air.

With the above described ultrasonic wave output device 1, when the ultrasonic speaker 10 generates heat, the heat conductor 30 releases the heat transmitted to the lead wire 14 to the outside of the space 23. Thus, the ultrasonic speaker 10 can be cooled as compared with the case where the space 23 is filled with air.

(1b) In the ultrasonic wave output device 1 described above, the heat conductor 30 includes the heat radiation gel 31 and the gel enclosure 32. The heat radiation gel 31 is constituted as a gel-like substance or liquid substance having the thermal conductivity higher than the thermal conductivity of air. The gel enclosure 32 is formed to have a shape of a bag that is closed. The gel enclosure 32 is disposed in the space 23 of the housing 20 in a state in which the heat radiation gel 31 is accommodated.

With the above described ultrasonic wave output device 1, since the heat radiation gel 31 constituted by the gel-like substance or the liquid substance is accommodated by the gel enclosure 32, the leakage of the heat radiation gel 31 from the housing 20 can be suppressed.

(1c) In the ultrasonic wave output device 1 described above, the gel enclosure 32 is constituted as the insulator.

With the above described ultrasonic wave output device 1, since the gel enclosure 32 is constituted as the insulator, the short circuit of a terminal such as the lead wire 14 can be suppressed even when the terminal is exposed in the space 23.

(1d) In the ultrasonic wave output device 1 described above, the heat radiation gel 31 is constituted as the heat radiation gel.

With the above described ultrasonic wave output device 1, since the heat radiation gel 31 is constituted as the heat radiation gel generally having the high thermal conductivity, the heat of the lead wire 14 can be conducted well to the outside of the housing 20.

### 2. Other Embodiments

Although the embodiments of the present disclosure have been described above, the present disclosure is not limited to the embodiments described above, and various modifications can be made to implement the present disclosure.

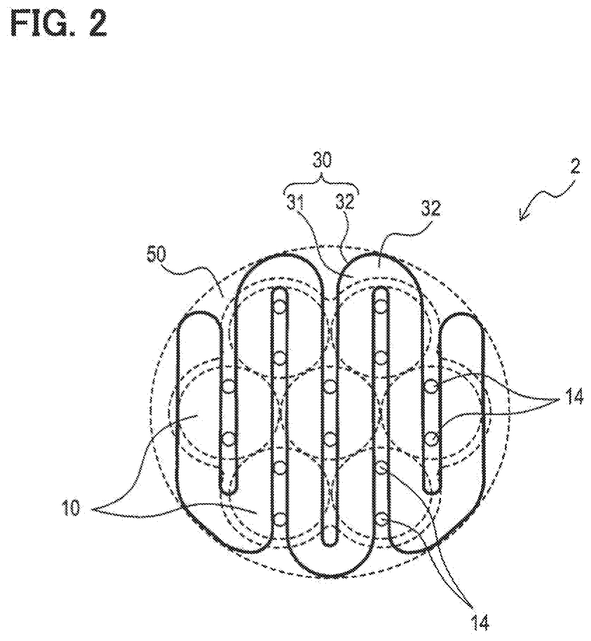

(2a) In the above embodiment, the plurality of heat conductors 30 are included. Alternatively, the configuration may not be limited thereto. In the above embodiment, one ultrasonic speaker 10 is included. Alternatively, the configuration may not be limited thereto. For example, a configuration shown in FIG. 2 can be employed.

An ultrasonic wave output device 2 shown in FIG. 2 includes a housing 50 instead of the housing 20, and a plurality of ultrasonic speakers 10 each having a pair of lead wires 14.

The housing 50 holds the plurality of ultrasonic speakers 10. The lead wires 14 is inserted into the space inside of the housing 50. FIG. 2 shows a rear view of the plurality of ultrasonic speakers 10, and the front side of the housing 50 in the drawing is a space not shown. In FIG. 2, description of the elements disposed in the front side rather than the printed circuit board 51 of the housing 50 is omitted.

In the space, the heat conductor 30 is disposed so as to cover the lead wires 14 of the plurality of ultrasonic speakers 10. The heat conductor 30 has a single elongated shape, and is folded so as to be disposed through the gap between the lead wires 14. In this configuration, the heat conductor 30 is disposed in contact with all the lead wires 14 and in contact with the housing 50.

Also in this case, substantially the same effect as the above (1a) can be obtained.

(2b) A plurality of functions of one element in the above embodiment may be implemented by a plurality of elements, or one function of one element may be implemented by a plurality of elements. Further, a plurality of functions of a plurality of elements may be implemented by one element, or one function implemented by a plurality of elements may be implemented by one element. A part of the configuration of the above embodiment may be omitted. At least a part of the configuration of the above embodiment may be added to or replaced with another configuration of the above embodiment. All modes included in the technical idea identified by the wording described in the claims correspond to embodiments of the present disclosure.

(2c) In addition to the above described ultrasonic wave output devices 1, 2, the present disclosure can be implemented in various forms such as a system which includes the ultrasonic wave output device 1, 2 as a component.

### 3. Correspondence Relation Between the Configuration of the Present Embodiments and the Configuration of the Present Disclosure

The ultrasonic speaker 10 in the embodiment corresponds to an ultrasonic wave output portion in the present disclosure, and the housing 20, 50 in the embodiment correspond to a hold portion in the present disclosure. In addition, the heat radiation gel 31 in the embodiment corresponds to a heat medium in the present disclosure, and the gel enclosure 32 in the embodiment corresponds to an accommodation portion in the present disclosure.

1. An ultrasonic wave output device comprising:
at least one ultrasonic wave output portion that includes at least one lead wire to which an input signal is input, and is configured to output an ultrasonic wave in response to the input signal;
a hold portion that has a space inside, and holds the at least one ultrasonic wave output portion outside the space with the at least one lead wire inserted in the space; and
a heat conductor that is in contact with an inner wall of the space and the at least one lead wire, and has a thermal conductivity higher than a thermal conductivity of air,
wherein
the heat conductor further includes:
a heat medium provided by a gel-like substance or a liquid substance having a thermal conductivity higher than the thermal conductivity of air; and
an accommodation portion having a bag shape with a closed end, and disposed in the space of the hold portion in a state in which the heat medium is accommodated.

2. The ultrasonic wave output device according to claim 1, wherein
the accommodation portion is constituted as an insulator.

3. The ultrasonic wave output device according to claim 1, wherein
the heat medium is provided by a heat radiation gel.
